(19) United States
(12) Patent Application Publication
(10) Pub. No.: US 2020/0189155 A1
(43) Pub. Date: Jun. 18, 2020

(54) PROCESS OF FOAMING IN A MOLD

(71) Applicants: Zhenhuan Luo, Dongguan (CN); Runhong Liu, Dongguan (CN)

(72) Inventors: Zhenhuan Luo, Dongguan (CN); Runhong Liu, Dongguan (CN)

(21) Appl. No.: 16/795,578

(22) Filed: Feb. 20, 2020

(51) Int. Cl. B29C 44/34; B29C 44/02

(52) U.S. Cl. CPC B29C 44/348; B29K 2023/0633; B29C 44/02

(57) ABSTRACT

A process of microcellular foaming an article includes the steps of opening a valve to convey a polyolefin material from a hopper to a mold; activating a pressurized device to increase pressure of the mold to a predetermined pressure by heating at a predetermined temperature; supplying SCF to the mold to effuse through the polyolefin material via a pipe, thereby generating SCF effused polyolefin material; after releasing the predetermined pressure, foaming the SCF effused polyolefin material in the mold in a ratio of 1 to 1; cooling the mold; opening the mold; and removing a finished foamed article out of the mold.

### BACKGROUND OF THE INVENTION

### 1. Field of the Invention

The invention relates to microcellular foam and more particularly to a process of foaming in a mold.

### 2. Description of Related Art

Physical or chemical foaming agents are added to polymeric foaming materials to form bubbles therein. The foaming process comprising the steps of forming gas bubbles, nucleation, and stabilization. Typically, gas under high pressure is dissolved into various polymers, relying on thermodynamic instability phenomena to cause the uniform arrangement of the gas bubbles.

Chinese Patent Number CN109517262A discloses a process of foaming using supercritical fluid (SCF) comprises the steps of effusing SCF through plastic granules in a hopper, and producing an article by injection molding or extrusion.

However, both the injection molding machine and the extrusion machine are expensive. Further, maintenance fee is very high. As a result, the manufacturing cost is greatly increased.

Chinese Patent Number CN110157086A discloses a process of physically foaming in a mold. The process comprises the steps of placing a mold in a pressure vessel, and a half-finished article is formed in the mold in a ratio of 1:1 while releasing pressure of the pressure vessel.

However, the mold is manufactured by an injection molding machine, an e extrusion machine, or a press. Thus, the manufacturing cost is greatly increased. Finally, the step of foaming the half-finished article is done in room temperature. As a result, the efficiency is very low.

Thus, the need for improvement still exists.

### SUMMARY OF THE INVENTION

It is therefore one object of the invention to provide a process of microcellular foaming an article, comprising the steps of opening a valve to convey a polyolefin material from a hopper to a mold; activating a pressurized device to increase pressure of the mold to a predetermined pressure by heating at a predetermined temperature; upplying a supercritical fluid (SCF) to the mold to effuse through the polyolefin material via a pipe, thereby generating SCF effused polyolefin material; after releasing the predetermined pressure, foaming the SCF effused polyolefin material in the mold in a ratio of 1 to 1; cooling the mold; opening the mold; and removing a finished foamed article out of the mold.

It is another object of the invention to provide a process of microcellular foaming an article, comprising the steps of opening a valve to convey thermoplastic elastomer from a hopper to a mold; activating a pressurized device to increase pressure of the mold to a predetermined pressure by heating at a predetermined temperature; after releasing the predetermined pressure, foaming the thermoplastic elastomer in the mold in a ratio of 1 to 1; cooling the mold; opening the mold; and removing a finished foamed article out of the mold.

The above and other objects, features and advantages of the invention will become apparent from the following detailed description taken with the accompanying drawings.

### BRIEF DESCRIPTION OF THE DRAWINGS

FIG. 1 schematically depicts a foaming apparatus incorporating a pressure vessel according to a first preferred embodiment of the invention; and

FIG. 2 schematically depicts a foaming apparatus incorporating a press according to a second preferred embodiment of the invention.

### DETAILED DESCRIPTION OF THE INVENTION

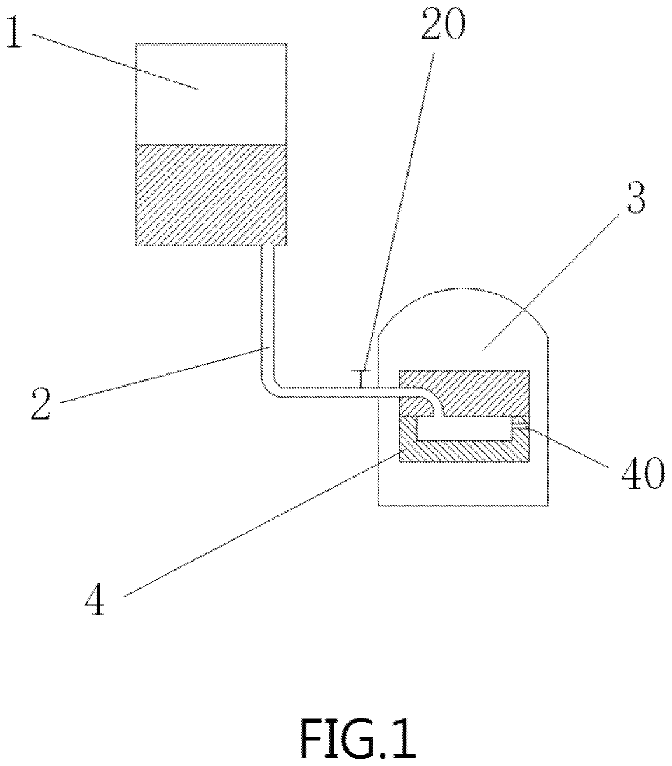

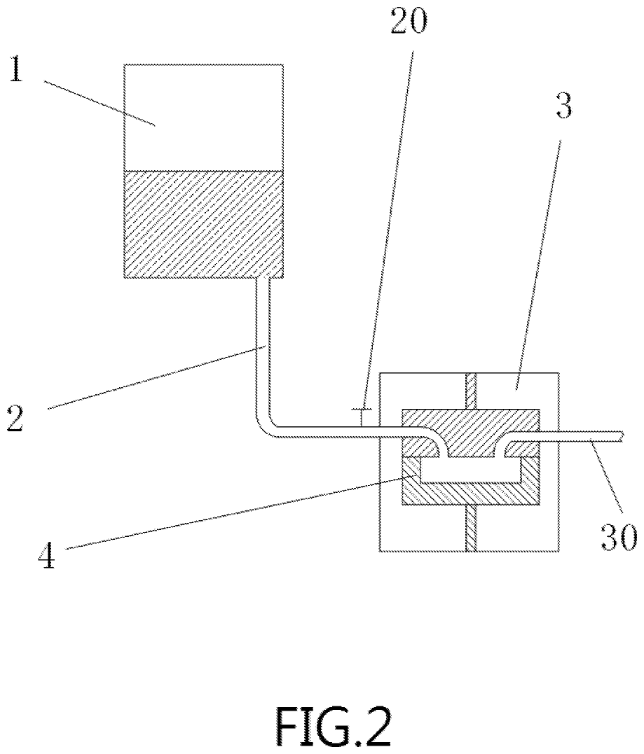

Referring to FIGS. 1 and 2, a foaming process is implemented in a foaming apparatus including a hopper 1, a pipe 2, a pressurized device 3 and a mold 4 in which one end of the pipe 2 is connected to the hopper 1 and the other end thereof is disposed in the mold 4. The mold 4 is provided in the pressurized device 3. A valve 20 is provided on the pipe 2.

The pressurized device 3 is a pressure vessel or a press (e.g., hydraulic press). If the pressurized device 3 is a pressure vessel, the mold 40 has a channel 40. If the pressurized device 3 is a press, it has a pressurized pipe 30 communicating with inside of the mold 4.

A first embodiment of the foaming process comprises the steps of (A) opening the valve 20 to convey plastic granules (e.g., polyolefin material) from the hopper 1 to the mold 4; (B) activating the pressurized device 3 to increase pressure of the mold 4 to a predetermined pressure by heating at a predetermined temperature; (C) supplying a supercritical fluid (SCF) to the mold 4 to effuse through the plastic granules via the pipe 30 or the channel 40, thereby generating SCF effused plastic granules; (D) after releasing pressure, foaming the SCF effused plastic granules in the mold 4 in a ratio of 1 to 1; (E) cooling the mold 4; (F) opening the mold 4 (i.e., separating an upper mold from a lower mold); and (G) removing a finished foamed article out of the mold 4.

A second embodiment of the foaming process comprises the steps of (A) opening the valve 20 to convey plastic granules (e.g., thermoplastic elastomer) from the hopper 1 to the mold 4; (B) activating the pressurized device 3 to increase pressure of the mold 4 to a predetermined pressure by heating at a predetermined temperature; (C) after releasing pressure, foaming the plastic granules in the mold 4 in a ratio of 1 to 1; (D) cooling the mold 4; (E) opening the mold 4 (i.e., separating an upper mold from a lower mold); and (F) removing a finished foamed article out of the mold 4.

Preferably, if the plastic granules are polyolefin material, prior to step (A) there is further provided the step (A0) of crosslinking the plastic granules to generate crosslinked plastic granules.

Neither injection molding machine nor extrusion machine is involved in the foaming process. Further, a buffer tank is not required. Thus, the manufacturing cost is greatly decreased. In addition, the heating step of the foaming process may melt or soften the foaming material. Thus, it is highly efficient and the plastic granules can be fully foamed.

Preferably, the plastic granules are formed of polyolefin material and they are included in a polyolefin compound. Preferably, at least one of crosslinking agents, fillers, and chemical additives are added to the polyolefin compound. The crosslinking agent reacts with molecules of the polyolefin compound to form bridges between polymer molecular links and in turn form an insolvable substance having a three-dimensional structure. The filler can improve performance or reduce production costs. The chemical additive can increase flowability. For the polyolefin compound having 100 parts per hundred rubber (phr), the crosslinking agent has 0.15 phr-1.1 phr or preferably 0.25 phr-1.0 phr, the filler has less than 30 phr, and the chemical additive has less than 10 phr.

Preferably, the crosslinking agent comprises peroxide; the filler comprises at least one of calcium carbonate, pulvistalci, mica powder, clay, zinc oxide and titanium dioxide; and the chemical additive comprises at least one of paraffin, stearic acid, ate complex and calcium salt.

The polyolefin compound comprises at least one of ethylene-vinyl acetate (EVA), polyolefin elastomer (POE), low-density polyethylene (LDPE), and polypropylene (PP).

Preferably, the polyolefin compound may be ethylene-vinyl acetate (EVA) having a 5%-40% mole, a combination of EVA and POE having a composition ratio of 100/0.1-0.1/100, or a combination of EVA, POE, and ethylene propylene diene monomer (EPDM) rubber having a composition ratio of 100/0.1/0.1-0.1/100/20.

The crosslinking agents comprise at least one of daichlorophenols (DCP) and Bis(tert-butylperoxy isopropyl) benzene (BIPB). The fillers comprise at least one of calcium carbonate, pulvistalci, zinc oxide, and titanium dioxide. The chemical additives comprise at least one of paraffin and stearic acid. The thermoplastic elastomer comprise at least one of thermoplastic polyurethane (TPU), thermoplastic polyester elastomer (TPEE), Pebax® thermoplastic elastomer, polyethylene (PE), and polypropylene (PP).

Preferably, the pressurized device 3 is a press. In comparison with the pressure vessel, the press has excellent heat transfer capability. Thus, the heating temperature is relatively low, i.e., energy saving. Further, the press has good conduction. Thus, the immersion time is short and the finished article is easy to remove. As a result, production is more efficient.

Preferably, the SCF is carbon dioxide, water, methane, ethane, methanol, ethanol, ethylene, propylene, acetone, nitrogen, or a combination thereof.

The effusion occurs at 5-60 MPa. The temperature ranges from being 5° C. greater than a softening point of the plastic granules to being 3° C. less than the softening point of the plastic granules. The effusion time lasts for 0.5-8 hours. The obtained SCF may effuse through the plastic granules. 1-10 w % of the plastic granules is effused by the SCF. When the effuse temperature is near the melting point of the material (e.g., the plastic granules), the material becomes molten. Thus, the SCF cannot effuse through the material. When the effuse temperature is near the softening point of the material, the material becomes hardened. Thus, the SCF cannot stay in the material.

In the step of foaming an article in the mold, the temperature ranges from being 25° C. less than a melting point of the plastic granules to being 25° C. greater than the melting point of the plastic granules. Prior to releasing pressure, the internal pressure of the mold ranges from being 0.1 MPa greater than 40 MPa to being less than or equal to 40 MPa. The pressure is kept the same for 0.2 to 5 hours. After releasing pressure, the foaming lasts for 5 to 10 minutes. The mold is opened when the mold has cooled to a temperature less than 40° C. The plastic granules are molten or softened when temperature is ±25° C. relative to its melting point. The foaming performance is the best at this temperature range and the foaming lasts for a minimum 5 minutes for fully foaming the plastic granules. Preferably, prior to releasing pressure, the internal pressure of the mold ranges from 10 MPa to 30 MPa.

The foamed article produced by the invention contains billions of tiny bubbles having a size from 0.1 to 3 micrometers and the bubbles have a specific gravity of 0.03-0.30 g/cm³.

In one experiment, the foamed article undergoes three fatigue tests repeatedly with a load of 10-80 kg. It is found that its stability is increased by 30% in comparison with the article made by a conventional EVA foaming material.

The foamed article has a bouncing capability of at least 50% by testing with a ball free falling test based on ASTM D2632. Also, the bouncing capability can be maintained for 10 to 60 days in comparison with the article made by a conventional EVA foaming material. This 10 to 60 days period is increased by 30% in comparison with that of the article made by a conventional EVA foaming material.

The foamed article has many applications including mats, shoes, exercise equipment, toys and packing materials. For a shoe as the produced foamed article of the invention, billions of tiny bubbles of the shoe have a size from 0.1 to 3 micrometers and the bubbles have a specific gravity of 0.05-0.30 g/cm³; and the shoe has a bouncing capability of at least 50% by testing with a ball free falling test based on ASTM D2632. For mat as the produced foamed article of the invention, billions of tiny bubbles of the mat have a size from 0.1 to 3 micrometers and the bubbles have a specific gravity of 0.03-0.20 g/cm³; and the shoe has a bouncing capability of at least 50% by testing with a ball free falling test based on ASTM D2632.

The foaming materials have advantages including low specific gravity, no pollution to the environment, excellent resilience, and smooth surface. The formed article is produced in only one process with a great reduction of the manufacturing cost.

After forming the mold, for increasing the linking strength of the molecules of the polyolefin compound, crosslinking is formed in the mold by chemical reactions that are initiated by heat, pressure, or electron beam irradiation. As a result, a crosslinked mold is obtained. For example, the mold is heated at a predetermined temperature range to form crosslinks therein. Specifically, the added crosslinking agent causes the molecules of the polyolefin compound to form crosslinks. Alternatively, electron beam irradiation of 20-50 kGy is applied to form crosslinks in the polyolefin compound.

### Embodiment 1

EVA (e.g., EVA7470 produced by Formosa Plastics Corporation) of 100 phr in which ethenyl acetate in the EVA has 26% mole, calcium carbonate of 1 phr, paraffin of 0.5 phr, and DCP of 0.5 phr are added to a mixer to mix for 12 minutes under conditions of 100° C. and 7 Mpa. Thereafter, steps of opening the valve to convey plastic granules from the hopper to the mold; and activating the pressurized device to increase pressure of the mold to a predetermined pressure by heating to a predetermined temperature. Then a SCF (e.g., carbon dioxide (CO₂)) is effused through the mixture for 2 hours under conditions of 90° C. and 40 Mpa. Plastic granules effused by the SCF are obtained. The effused plastic granules have a foaming ratio of less than 1.5 and the SCF has 10 w % of the plastic granules. Prior to releasing pressure, the internal pressure of the mold is 40 PMa and temperature is 90° C. In the foaming step, the internal pressure of the mold is decreased to 0.1 PMa (normal pressure) and the foaming step lasts for 5 seconds. After releasing pressure, foaming the plastic granules in the mold in a ratio of 1 to 1, and particles of the foam melt to join. After the foaming, the mold is cooled to 40° C. Next, the mold is opened. Finally, a finished foamed article having a smooth surface is produced and removed out of the mold.

Bubbles of the finished foamed article are measured by an optical microscope, and density thereof is measured by a specific gravity scale. Bouncing capability of the finished foamed article is tested based on ASTM D2632: a conic steel ball having weight of 28±0.5 g free falls on a sample of foaming plastic from a height of 400 mm in which the ratio of a bouncing height of the steel ball to 400 mm is the bouncing capability of the finished foamed article. The finished foamed article has a specific gravity of 0.15 to 0.16, an average diameter of the bubbles in the finished foamed article is 0.8-2.5 mm, and the bouncing capability of the finished foamed article is 55%.

### Embodiment 2

EVA is replaced by a compound of EVA (60%)/POE (40%) in which ethenyl acetate in the EVA has 26% mole, and POE having a serial number 8150 is produced by Dows Inc. Other manufacturing steps are the same as that of embodiment 1. The produced article is a foamed article.

The produced foamed article has a specific gravity of 0.13, an average diameter of the bubbles in the produced foamed article is 0.5-2.0 mm, and the bouncing capability of the produced foamed article is 60%.

### Embodiment 3

EVA is replaced by a compound of EVA (60%)/POE (40%) in which ethenyl acetate in the EVA has 26% mole, and POE having a serial number 8150 is produced by Dows Inc. Further, CO2 is replaced by nitrogen as SCF. Other manufacturing steps are the same as that of embodiment 1. The produced article is a foamed article.

The produced foamed article has a specific gravity of 0.15, an average diameter of the bubbles in the produced foamed article is 0.5-2.5 mm, and the bouncing capability of the produced foamed article is 58%.

### Embodiment 4

EVA is replaced by a compound of TPU having a serial number 85AU10 produced by Sistron Inc. and the steps of mixing and crosslinking are omitted. Other manufacturing steps are the same as that of embodiment 1. The produced article is a foamed article.

The produced foamed article has a specific gravity of 0.28, an average diameter of the bubbles in the produced foamed article is 0.5-1.5 mm, and the bouncing capability of the produced foamed article is 55%.

### Exemplary Example 1

The conventional MuCell® Molding Technology is used in which a SCF foaming device is used to produce TPU foaming articles. Hopper is heated to 210° C. and the mold is heated to 30° C. SCF (e.g., nitrogen) is introduced to the injection molding machine to mix with molten TPU. The molten TPU mixture is injected into a mold cavity to form. The SCF reacts with the molten TPU mixture to form bubbles in the mold cavity.

The produced foamed article has the same size as that of the mold cavity but has irregularities on the surface. The produced foamed article has a specific gravity of 0.4-0.55, an average diameter of the bubbles in the produced foamed article is 0.8-2.0 mm, and the bouncing capability of the produced foamed article is 50%.

### Exemplary Example 2

except the foaming temperature is 50° C., other manufacturing steps are the same as that of embodiment 1. The produced article is a foamed article.

The produced foamed article has a specific gravity of 0.45, an average diameter of the bubbles in the produced foamed article is 0.2-0.5 mm, the bouncing capability of the produced foamed article is 35%, and the foaming lasts for 20 minutes. It is understood that foaming lasts is relatively lower (i.e., relative to melting point of the material) and thus it lower the foaming performance. Further, the specific gravity, the average diameter of the bubbles in the produced foamed article, and the bouncing capability of the produced foamed article do not meet the requirement.

### Exemplary Example 3

except the crosslinking agent DCP in the embodiment 1 has 1.25 phr, other manufacturing steps are the same as that of embodiment 1.

The produced article is a foamed article. The produced foamed article has a specific gravity of 0.32, an average diameter of the bubbles in the produced foamed article is 0.2-0.8 mm, and the bouncing capability of the produced foamed article is 40%.

### Exemplary Example 4

except the crosslinking agent DCP in the embodiment 1 has 0.12 phr, other manufacturing steps are the same as that of embodiment 1. The produced article is a foamed article.

The produced foamed article has a specific gravity of 0.42, an average diameter of the bubbles in the produced foamed article is 0.2-0.6 mm, and the bouncing capability of the produced foamed article is 35%.

### Exemplary Example 5

except the crosslinking agent DCP in the embodiment 2 has 0.12 phr, other manufacturing steps are the same as that of embodiment 2.

The produced article is a foamed article. The produced foamed article has a specific gravity of 0.35, an average diameter of the bubbles in the produced foamed article is 0.1-0.8 mm, and the bouncing capability of the produced foamed article is 42%.

While the invention has been described in terms of preferred embodiments, those skilled in the art will recognize that the invention can be practiced with modifications within the spirit and scope of the appended claims.

What is claimed is:

1. A process of microcellular foaming an article, comprising the steps of:
(A) opening a valve to convey a polyolefin material from a hopper to a mold;
(B) activating a pressurized device to increase pressure of the mold to a predetermined pressure by heating at a predetermined temperature;
(C) supplying a supercritical fluid (SCF) to the mold to effuse through the polyolefin material via a pipe, thereby generating SCF effused polyolefin material;
(D) after releasing the predetermined pressure, foaming the SCF effused polyolefin material in the mold in a ratio of 1 to 1;
(E) cooling the mold;
(F) opening the mold; and
(G) removing a finished foamed article out of the mold.

2. The process of claim 1, wherein the SCF is carbon dioxide, water, methane, ethane, methanol, ethanol, ethylene, propylene, acetone, nitrogen, or a combination thereof.

3. The process of claim 1, wherein the effusion occurs at 5-60 MPa, the temperature ranges from being 5° C. greater than a softening point of the polyolefin material to being 3° C. less than the softening point of the polyolefin material, and the effusion time lasts for 0.5-8 hours.

4. The process of claim 1, further comprising the step (A0) of crosslinking the plastic granules to generate a crosslinked polyolefin material prior to step (A).

5. The process of claim 1, wherein the pressurized device is a press.

6. The process of claim 1, wherein the polyolefin material is included in a polyolefin compound; and wherein at least one of crosslinking agents, fillers, and chemical additives are added to the polyolefin compound.

7. The process of claim 6, wherein the polyolefin compound comprises at least one of ethylene-vinyl acetate (EVA), polyolefin elastomer (POE), low-density polyethylene (LDPE), and polypropylene (PP).

8. The process of claim 1, wherein the crosslinking agent comprises peroxide; wherein the filler comprises at least one of calcium carbonate, pulvistalci, mica powder, clay, zinc oxide and titanium dioxide; and wherein the chemical additive comprises at least one of paraffin, stearic acid, ate complex and calcium salt.

9. A process of microcellular foaming an article, comprising the steps of:
(1) opening a valve to convey thermoplastic elastomer from a hopper to a mold;
(2) activating a pressurized device to increase pressure of the mold to a predetermined pressure by heating at a predetermined temperature;
(3) after releasing the predetermined pressure, foaming the thermoplastic elastomer in the mold in a ratio of 1 to 1;
(4) cooling the mold;
(5) opening the mold; and
(6) removing a finished foamed article out of the mold.

10. The process of claim 9, wherein in step (3), the predetermined temperature ranges from being 25° C. less than a melting point of the thermoplastic elastomer to being 25° C. greater than the melting point of the thermoplastic elastomer; wherein prior to releasing the pressure, an internal pressure of the mold ranges from being 0.1 MPa greater than 40 MPa to being less than or equal to 40 MPa; wherein the predetermined pressure is kept the same for 0.2 to 5 hours; wherein after releasing the pressure, the foaming lasts for 5 to 10 minutes; and the mold is opened when the mold has cooled to a temperature less than 40° C.

11. The process of claim 9, wherein the thermoplastic elastomer comprise at least one of thermoplastic polyurethane (TPU), thermoplastic polyester elastomer (TPEE), polyethylene (PE), and polypropylene (PP).
